(19) United States
(12) Patent Application Publication
(10) Pub. No.: US 2005/0044014 A1
(43) Pub. Date: Feb. 24, 2005

(54) Public network privacy protection tool and method

(76) Inventors: Reuben Tilis, Jerusalem (IL); Mordechai Levi, State College, PA (US)

Correspondence Address: Mordechai Levi, 1511 South Allen Street, State College, PA, 16801, US

(21) Appl. No.: 10/499,145

(22) PCT Filed: Dec. 22, 2002
(86) PCT No.: PCT/IL02/01027

(30) Foreign Application Priority Data
Dec. 20, 2001 (IL) 147229

(51) Int. Cl. G06F 17/60

(52) U.S. Cl. 705/30

(57) ABSTRACT

A method and tool for facilitating data and commercial transactions over a public network enable a user to maintain full control of personal data. Information, including payment information, is provided by a supplier to a user requesting provision of a service or product. In order to facilitate a transaction, the user arranges, via a bank, credit card institution or other fiduciary organization, for payment directly to the account of the supplier together with an identification of the goods or service required. Thereafter, the bank, credit card institution or other fiduciary organization arranges for payment directly to the account of the supplier and identifies the required goods or service to the supplier. The goods or service are then delivered to the user. Such transactions may be optionally performed by use of a single step on the part of the user.

### FIELD OF THE INVENTION

The present invention generally relates to an electronic commerce protocol. More specifically, the present invention relates to a secure electronic commerce protocol, which protects the privacy of users.

### BACKGROUND OF THE INVENTION

A common form of electronic commerce protocol is described in U.S. Pat. No. 5,960,411, to Hartman entitled “Method and system for placing a purchase order via a communications network”. This is the well-known, so-called “one click” method for initiating a purchase order in an Internet commerce transaction.

U.S. Pat. No. 5,960,411 generally relates to the following list of steps: An order is placed by a buyer at a customer system and received by a server system. The server system receives buyer information including identification of the buyer, payment details, and delivery information from the buyer system. The server system then assigns a customer identifier to the customer system and associates the assigned customer identifier with the received buyer information. The server system sends to the buyer system the assigned buyer identifier and an HTML document identifying the item and including an order button. The customer system receives and stores the assigned customer identifier and receives and displays the HTML document. In response to the selection of the order button, the customer system sends to the server system a request to purchase the identified item. The server system receives the request and combines the customer information associated with the customer identifier of the customer system to generate an order to purchase the item in accordance with the billing and delivery information whereby the purchaser effects the ordering of the product by selection of the order button.

While U.S. Pat. No. 5,960,411 teaches a facile electronic commerce protocol, privacy remains a very significant remaining problem of this Internet protocol with regard to any transaction or communication between, for example, a user and a supplier. The issue of privacy is one of the major problems that constricts the Internet from further commercial transaction growth. Data-Communications professionals frequently consider that the problem relates to data security. However, to the average Internet user, the problem revolves around controlling access and privacy with respect to his own information, such as credit card details, income, personal data, and the like.

Many Internet users hesitate to enter into any commercial transactions, particularly buying on the Internet, as a consequence of the fear of losing control of personal information and the possibility of consequential fraud. There is a consensus amongst many users to maintain privacy. Nevertheless users still want to enjoy services befitting their needs, i.e. to be informed of available products and services and to be able to buy anything, anywhere without the risk of compromising their privacy and security and, specifically, without the risk of being defrauded.

At the present time, if a user decides to make a purchase, it is necessary to give credit card details on a so-called “secure” server to initiate the purchase, in order that the supplier may claim payment of the purchase consideration from the credit card company. Generally, a buyer is not offered any alternative payment mechanism to conclude an Internet purchase. There is nothing to prevent repeated use of the credit card details by a fraudulent supplier for other unauthorized transactions without informing the user. Furthermore there is the risk that the supplier, in all good faith, loses control of the credit card details due to a security leak on the server or within the organization. In other words, the user has at present no option but to implicitly trust an otherwise faceless supplier organization, its system and its personnel.

Referring to FIG. 1, it is generally appreciated that an ordinary purchase transaction executed over the Internet and paid by credit card, includes the following steps:
a) User 102 transmits his credit card details to a supplier 103;
b) Supplier 103 conveys the credit card details and other transaction details to a credit card or finance company 106;
c) Credit card company 106 transfers money to supplier 103;
d) User 102 reimburses the credit card company 106;
e) Credit card company 106 delivers transaction information to user 102; and
f) Supplier 106 delivers the goods or services ordered to user 102.

A result of step a) of the process is that user 102 loses control of his credit card details and his privacy.

The risks involved in the loss of control of the user's credit card details to a supplier and to the personnel employed by the supplier is self-evident. Apart from the possibility of fraud, the demand by the supplier that the user disclose further personal information infringes the user's privacy and confidentiality.

Moreover, from time to time users are requested to complete a variety of forms, for example, if a user wishes to subscribe to a service it is not uncommon that personal information is required, such as average income, marital status, hobbies, address and so on. This creates two specific problems: firstly, the user has no way of knowing where and how this information may be used, for example, for a tax investigation, to be passed on to other parties for disseminating advertisements and promotional data, just to mention a few. Secondly, the user may avoid giving extensive and perhaps valid information, and possibly even resort to giving false or misleading information.

Once again, the difficulty revolves about the user having to implicitly trust the other party. No one is predisposed to trust faceless people. This is especially so on the Internet, where there is often no knowledge or certainty per se of the trustworthiness of a vender. Nonetheless, it is presently an imperative and inescapable reality that personal information as detailed above must be provided by a user in order to request services or goods via the Internet.

Referring now to FIG. 2, a common method of operation between a user 202 and a provider 203 of information, services or goods on the Internet is:
a) User 202 is required to supply some limited personal information to a provider 203; and
b) Provider 203 utilizes this information in order to push various services, promotional items and so on to the user.

The result is that user 202 loses control of this personal information and his privacy, especially insofar as the provider becomes capable of passing on such personal information to any other parties beyond the control of the user.

More specifically, manipulation of voluntarily given information on the Internet all too often results in both the original supplier and perhaps many other parties being enabled to “push” information, services and goods to an unsuspecting user. This represents an invasion of privacy rights and often gives rise to a multiplicity of computer hardware problems including the proliferation of so-called junk mail and an increase in the risk of exposure to computer viruses. Therefore, it would seem that there is a need to eliminate the ability of suppliers to receive personal data from users in order to provide them with goods and services and to provide a more secure method of providing essential details in a money or data transaction.

Advantages, Objects and Benefits of the Invention

Technical Issues:

Embodiments of the present invention provide a substantially less complex procedure for payment for Internet or like commercial transactions. The variation of the procedure has fewer steps and significantly reduces the security risk to the user.

Ergonomic Issues:

The user is no longer required to expose private and confidential information to faceless organizations or individuals. Embodiments of the present invention enable transactions to be completed on a “need-to-know” basis. Also, the risk of personal information being passed to parties beyond the particular transaction is substantially reduced. In addition, the passing of information is reversed insofar as the supplier provides nominal information to the user.

Economic Issues:

Considering that there exists a substantial resistance by users to the continued growth and expansion of so-called E-commerce, embodiments of the present invention provide an innovative alternative to the present system employed to secure payment for Internet or other electronic media transactions. With users made to feel that their privacy and exposure to being defrauded is substantially reduced, the continued growth of E-commerce is made possible.

### Notices

Numbers, alphabetic characters, and roman symbols are designated in the description for convenience of explanation only, and should by no means be regarded as imposing particular order on any method steps, unless specifically stated otherwise. Likewise, embodiments of the present invention will forthwith be described with a certain degree of particularity, however those versed in the art will readily appreciate that various modifications and alterations may be carried out without departing from either the spirit or scope, as hereinafter claimed.

In describing embodiments of the present invention, explanations are presented in light of currently accepted Technological, Mercantile, or Data-Communications theories and models. Such theories and models are subject to changes, both adiabatic and radical. Often these changes occur because representations for fundamental component elements are innovated, because new transformations between these elements are conceived, or because new interpretations arise for these elements or for their transformations. Therefore, it is important to note that the present invention relates to specific technological actualization in embodiments. Accordingly, theory or model dependent explanations herein, related to these embodiments, are presented for the purpose of teaching those skilled in the art how these embodiments may be substantially realized in practice. Alternative or equivalent explanations for these embodiments may neither deny nor alter their realization.

Various terms including “provider”, “supplier”, and “seller”, are employed throughout this application in respect of an entity, typically accessible through an Internet site, with whom a user may seek to interact. Such interaction may be by way of performing a financial transaction for the purchase of goods, services and/or information, and many of the examples in the present application relate to such a transaction.

It will be appreciated, however, that the present invention relates primarily to the controlled dissemination of “non-nominal” data, namely, that data, which cannot be used to identify a user, thereby constituting an invasion of privacy as, described at length herein. It is therefore, of no significance whether a secure ‘transaction’ facilitated by the present invention involves funds, provision of goods or services, or merely involves an exchange of data.

The term ‘secure transaction’ is thus used to mean a two-way exchange of data, regardless of whether the ‘currency’ of exchange, at least on the side of a user, is information and money in combination, or merely information. Where the term ‘commerce’ is used, this should be taken to refer specifically to a transaction involving money, only where a broader interpretation is not applicable.

Fiduciary system can mean any organization, including, but not limited to banks, credit card companies and other institutions, whether financial in nature or not, capable of handling third-party transactions, including organizations which may not necessarily thought of as conventionally handling third-party transactions.

### SUMMARY OF THE INVENTION

The present invention seeks to provide a method and tool for facilitating data and commercial transactions over the Internet, while enabling a user to maintain full control of all nominal data, thereby overcoming disadvantages of the prior art.

There is thus provided, in accordance with a preferred embodiment of the invention, a secure transaction agent, embodied in software resident in a machine readable device, for facilitating a secure transaction between a user and an entity, with whom the user may seek to interact, the agent including:
means for receiving from an Internet browser used by a user, nominal and non-nominal information associated with the user;
means for storing the information in a user file, so as to construct a user profile;
means for receiving transaction rules from a remote entity with whom the user may seek to interact;
means for determining the relevance of the transaction rules to the user profile; and
means for sending selected information associated with the user, to the remote entity, in accordance with the transaction rules received therefrom.

The present invention further relates to embodiments of a secure electronic transaction protocol for use between on the one hand a seller offering to sell at least one item and on the other hand a buyer interested in accepting the offer and thereby buying at least one item offered for sale by the seller. These embodiments relate, inter alia, to a method for accomplishing a critical transaction typical to electronic commerce, that is, to facilitate secured payment between a buyer and a seller. While securing not only the credit card or other monetary payment instruments of the buyer, these embodiments also relate to securing personal information, which is not pertinent to the transaction, and which may be subject to abuse. The protocol includes the step of using at least one electronic data-communications media, on the seller's side, for publishing for a buyer an offer having a transaction reference identifier linking a price schedule to the at least one item, and a seller's deposit account address. The protocol also includes the step, on the buyer's side, of sending to a fiduciary an acceptance-of-the-offer authorization having a transfer-of-funds authorization according to the price schedule, the transaction reference identifier and the seller's deposit account address. On the fiduciary's side, the protocol further includes receiving the authorization, and completing the buyer's acceptance-of-the-offer by sending to the seller's deposit account address, the finds according to the transfer authorization, and the transaction reference identifier.

More specifically, a supplier provides information to a user regarding a product or service, for example, in the form of a price list or as a quotation together with the supplier's bank deposit account details. Should the user decide to make a purchase or receive the offered service or data, the user arranges, via a bank, credit card institution or other fiduciary organization of his choice, for payment directly to the account of the supplier together with an identification of the goods or service required. Thereafter, the bank, credit card institution or other fiduciary organization arranges for payment directly to the account of the supplier and identifies the required goods or service to the supplier. The goods or service are then delivered to the user.

The major advance accomplished by this procedure, compared to the presently utilized procedure in regard to Internet transactions, is that the user's privacy remains intact. Information concerning the user is limited to the bank, credit card institution or other fiduciary organization of the user's choice. No personal information is provided directly or indirectly to the supplier other than a delivery address, avoiding the risks of fraud or personal information being utilized for any purpose outside the specifically desired transaction. It is possible to even limit the details regarding the delivery address by employing a third party delivery service in much the same manner as is described heretofore with regard to the payment technique.

Furthermore, the user has no mechanism for interfering with the deposit account of the seller other than to arrange for payment for goods or services ordered. This also provides the supplier with a measure of privacy and security. A significant feature of embodiments of the present invention is to limit the availability of the personal information of each of the parties to a transaction. The exposure of each party and, most particularly, the user, is kept to a pragmatic minimum.

It should also be noted that the present invention relates to an information corollary to the strict electronic commerce application protocol. Generally, other embodiments of the present invention relate to facilitating secured delivery of information relevant to a transaction; without regard to that transaction including a secured payment related content or not including a secured payment related content.

More specifically, these “information relevant” embodiments relate to an information agent of an Internet-type “buyer-side” (user) receiving and emulating rule-based data structure navigation aspects from an information agent of an Internet-type (electronic data-communications media) seller-side—even if the particulars of the information agent to information agent data-content transfer does not contain any aspect related to accomplishing an electronic commerce transaction. According to a further aspect of seller-side agent to buyer-side agent information only transfers, the buyer side may report aspects of his internal agent emulation activities to an information fiduciary-side. The fiduciary will bundle groups of buyer side reports into a single anonymous collective report that will in turn be conveyed to the seller side for providing the seller side with information about the buyer side population WITHOUT breaching the privacy of any specific buyer-side user.

It should be appreciated that the “information relevant” embodiments are not fundamentally different from the “facilitate secured payment” embodiments of the protocol of the present invention. Specifically, the principle embodiment of the present invention exemplified as relating to “facilitate secured payment” is a tripartite protocol having a seller side publishing, a buyer side authorizing, and a fiduciary side completing the transaction by binding the authorizing to the publishing. Likewise, the embodiment of the present invention exemplified as relating to “information relevant” transactions is a tripartite protocol. A seller side publishing rule-based data structure navigation aspects uses a seller side agent. A buyer side receives and emulates these rule-based data structure navigation aspects using a buyer side agent. Thereafter, a fiduciary side completes the transaction by providing the seller side with information about the buyer side population.

Embodiments of the present invention also relate to a proactive buyer responding to an advertisement or some other ongoing offer to the Internet public or even to specific presentations in magazine, news or any other electronic advertising media. Having noted a specific offer, and without having to compromise any aspect of privacy, a buyer can arrange payment authorization, together with transaction identification and details of the seller's deposit account through a fiduciary, bank or credit card organization, directly into the seller's deposit account.

According to an additional embodiment of the present invention, the buyer's side is empowered by an authorized buyer search agent. This means that, for example, a buyer or purchasing organization can set up a search engine to acknowledge and respond to any available items of specific interest and within a given price range. A collector of a specific type or category of postage stamps can set up a search engine to systematically check availability from suppliers on the Internet and automatically respond where appropriate. Preserving user privacy is valuable for such transactions insofar as the seller is unable to “push” unwanted advertising or goods on to a buyer.

According to a further embodiment of the present invention, the seller's side is empowered by an authorized seller presentation agent. The authorized seller presentation agent can include, for example, a web page, an online price list presentation, catalogue or automatically transmitted SMS's.

According to an added embodiment of the present invention, the buyer's side and the fiduciary side constitute a single entity, thereby facilitating direct buyer acceptance of the seller's offer. Simply stated, a buyer responding to an offer of goods or services can arrange direct payment to a seller's account. Furthermore, such a buyer can arrange a single payment for multiple purchases.

Also, according to an embodiment of the present invention, the at least one item is selected from a list of goods or services or information. This enables a buyer to purchase a bundled number of items from a catalogue or price list and to then make a payment for the whole bundled purchase instead of item by item.

Furthermore according to an embodiment of the present invention, completing the buyer's acceptance-of-the-offer includes the fiduciary's side receiving from the seller's side a purchase order receipt, or a work order receipt, or a contract closure confirmation receipt. The implication is that a buyer has transmitted by electronic media, or any other media, the details of a purchase directly to a seller. The seller is limited to accessing an authorized banking or credit card organization without obtaining direct access to a specific bank account or credit card account and this then avoids direct and potentially unlimited access by a seller to a buyer's account.

According to another embodiment of the present invention, completing the buyer's acceptance-of-the-offer includes the buyer's side receiving from the seller's side a purchase order receipt or a work order receipt or a contract closure confirmation receipt. Alternatively stated, a seller responds to a buyer's offer-to-purchase with a confirmation which can include confirmatory details such as availability, delivery date, quantity, size and so on, as well as the seller's deposit account details. The buyer is then able to effect payment through a selected fiduciary organization directly to the seller without having risked the presentation of personal banking or other details.

According to one other embodiment of the present invention, completing the buyer's acceptance-of-the-offer includes the buyer's receiving from the fiduciary's side a purchase order receipt or a work order receipt or a contract closure confirmation receipt. Simply stated, receipt by a buyer from the fiduciary organization of details of a purchase enables the buyer to follow-up deliver of the goods selected.

According to additional embodiments of the present invention, any one of the seller's side, the buyer's side or the fiduciary's side is an intelligent agent. These are programs, used extensively on the Web, that perform tasks such as retrieving and delivering information and automating repetitive tasks. Some new enhanced web browsers already fulfill some of the functions of intelligent agents.

According to an added embodiment of the present invention, the identity of the buyer's side is maintained in confidentiality by the fiduciary's side, thereby preserving anonymity of the buyer's side from the seller's side. Simply stated, the fiduciary side receives instructions from the buyer to pay the seller on behalf of the buyer, without exposing any details, and most specifically banking details, of the buyer.

According to one other embodiment of the present invention, secure electronic transaction protocol publishing includes an extended markup language (XML) descriptor. XML is designed especially for Web documents. It allows designers to create their own customized tags, enabling the definition, transmission, validation, and interpretation of data or commodities between applications and between organizations.

According to additional embodiments of the present invention, one or more of the seller's side, the buyer's side or the fiduciary's side is server resident. A server is merely a computer or other device for managing resources. Servers are often dedicated, meaning that they perform no other tasks besides their server tasks. Simply stated, any of the seller, the buyer and the fiduciary can be a server on the Internet and, therefore, is directly accessible for processing transactions.

Embodiments of the present invention further relate to a computer program product including a computer usable medium having computer readable program code embodied therein for a secure electronic commerce protocol, the computer readable program code in the computer program product including: using at least one electronic data-communications media on the buyer's side,
a) first computer readable program code for causing a computer to send to a fiduciary an acceptance-of-the-offer authorization having therein a funds transfer authorization according to the price schedule;
b) tied to the first computer readable software, second computer readable program code for causing the computer to send to a fiduciary an acceptance-of-the-offer authorization having therein the transaction reference identifier; and
c) tied to the second computer readable software, third computer readable program code for causing the computer to send to a fiduciary an acceptance-of-the-offer authorization having therein the seller's deposit account address.

Embodiments of the present invention further relate to a computer program product including a computer usable medium having computer readable program code embodied therein for a secure electronic commerce protocol, the computer readable program code in the computer program product including: using at least one electronic data-communications media on the fiduciary's side,
a) first computer readable program code for causing a computer to receive the authorization and to complete the buyer's acceptance-of-the-offer by sending to the seller's deposit account address the funds according to the transfer authorization; and
b) tied to the first computer readable software, second computer readable program code for causing the computer to receive the authorization, and complete the buyer's acceptance-of-the-offer by sending to the seller's deposit account address the transaction reference identifier.

Embodiments of the present invention additionally relate to a program storage device readable by machine, tangibly embodying a program of instructions executable by the machine to perform method steps for a secure electronic commerce protocol, the method steps including: using at least one electronic data-communications media on the seller's side, publishing for a buyer an offer having therein
a) a transaction reference identifier linking a price schedule to the at least one item; and
b) a seller's deposit account address.

A privacy agent may, in accordance with an alternative embodiment of the present invention, be a program storage device readable by machine, tangibly embodying a program of instructions executable by the machine to perform method steps for a secure electronic commerce protocol, the method steps including: using at least one electronic data-communications media, on the buyer's side sending to a fiduciary an acceptance of an offer authorization having therein:
a) a funds transfer authorization according to the price schedule,
b) a transaction reference identifier; and
c) a seller's deposit account address.

Embodiments of the present invention in addition relate to a program storage device readable by machine, tangibly embodying a program of instructions executable by the machine to perform method steps for a secure electronic commerce protocol, the method steps including: using at least one electronic data-communications media on the fiduciary's side, receiving the authorization, and completing the buyer's acceptance-of-the-offer by sending to the seller's deposit account address,
a) funds according to a transfer authorization; and
b) a transaction reference identifier.

One example should suffice to illustrate the information-relevant transaction type embodiments. An Internet surfer would like to explore information at an Internet site without being forced to give private details about himself, his interests, etc. The surfer (user) downloads to his resident agent rule-based data structure navigation aspects, which can be emulated within the user's control and particularly outside of the purview of the site owner. The user then emulates those aspects of the site interactively and privately; with as many iterations of the surfing/download/emulation as desired. Thereafter, the user delivers user elected profile data to a fiduciary, who bundles it with profile data delivered from other users into a substantially anonymous user population profile report (to the fiduciary site owner.

In accordance with further embodiments of the present invention of a secure electronic commerce protocol, sending a funds transfer authorization to the fiduciary includes authorizing preselected partial payments over a preselected time period.

According to a variation of the embodiment of the present invention, authorizing preselected partial payments over a preselected time period in accordance with a code issued by the fiduciary's side, such that the code includes at least one identifier selected from the group comprising: seller identifier; buyer identifier; preselected partial payment amount; preselected time period for payment; and individual payment identifier.

According to yet another variation of the embodiment, the code includes preselected code characters which indicate predetermined information, including information selected from the group comprising: payment number of current payment due; number of outstanding payments; payment time limit; and amount outstanding.

Also, according to one other variation of the embodiment, sending a funds transfer authorization to the fiduciary includes authorizing a time limitation for the transfer of finds in accordance with a code issued by the fiduciary's side. The code includes at least one identifier selected from: seller identifier; buyer identifier; preselected partial payment amount; preselected time period for payment; and individual payment identifier.

In accordance with another preferred embodiment of the present invention, there is a fiduciary system for transacting a purchase of at least one item on behalf of a buyer such that the privacy of the buyer is maintained and protected. The system comprises: a first transaction component; and a buying component. The buying component includes a data storage medium for receiving and providing data relevant to a plurality of buyers, such that the privacy of each buyer is preserved and protected,
an order receiving component for receiving a buying request to transact a purchase of at least one item on behalf of a buyer, in response to a buying request sent by the buyer, and
an ordering component to retrieve data from the data storage medium for the buyer so as to facilitate transacting the purchase of the at least one item on behalf of the buyer; and

The system further comprises a second transaction component, such that, in response to the buying request, the fiduciary initiates the transaction relating to one or more items, whereby the fiduciary provides to the seller payment and predetermined information. This information includes: shipping details, quantity of items ordered, delivery address and packaging specification.

According to an embodiment of the present invention, the fiduciary system, in which the buying request is initiated by application of a buyer identification device, there is software embodied therein, to a secure login reader connected to a public access network.

According to an embodiment of the present invention, in the fiduciary system the buying request is sent by a buyer system to a fiduciary system in response to at least one action being performed by the buyer system.

In accordance with a further preferred embodiment of the present invention, the method of conducting a transaction between a buyer, a seller, and a fiduciary, in respect of at least one item to be purchased by the buyer from the seller preserves the privacy of the buyer, even though a client is not installed on a computer used by the buyer for the transaction. The method includes the steps for the buyer of recording an item identifier and a seller identifier for at least one item, of logging on to a secure fiduciary site; and of sending a purchase request to the fiduciary site to purchase the at least one item together with the item identifier and the seller identifier
for a fiduciary system the steps are receiving the purchase request, retrieving buyer data from a fiduciary database relating to a buyer identifier, confirming the identity of the buyer, opening the seller's payment form; and authorizing the seller to fill the purchase request received from the buyer, while retaining the confidentiality of buyer specific data contained in the fiduciary database.

The present invention also aims to provide a single-step method and system for conducting a transaction, such as placing an order using an electronic media for the supply of goods or services, without disclosing confidential or banking information concerning the buyer.

According to a preferred embodiment of the present invention, there is provided a method conducting a transaction between a buyer, a seller, and a fiduciary, in respect of at least one item to be purchased by the buyer from the seller by use of a single-step ordering system, whereby the privacy of a buyer is preserved and protected. The method comprises, for a buyer system, recording an item identifier and a seller identifier for one or more items, and sending a single-step request to a fiduciary system to purchase the one or more items together with the item identifier and the seller identifier. For a single-step fiduciary system, the method comprises receiving the request, retrieving data from a fiduciary database relating to the buyer identifier, creating an order to purchase the one or more items in the received request on behalf of the buyer identified by the buyer identifier using the retrieved buyer data, and transacting the order to complete purchase of the one or more items, whereby the item is ordered while preserving the privacy of the buyer.

According to an embodiment of the present invention, the method of placing an order further includes recording an item identifier and a seller identifier.

According to another embodiment of the present invention, the method of placing an order includes the sub-step of entering a single touch purchase command when a cursor is positioned over a predefined area of displayed information.

According to an added embodiment of the present invention, the method of placing an order includes generating an identification sound signal by the buyer.

According to added embodiments of the present invention, the method further includes, prior to the step of sending a purchase request, the additional step of logging on to a fiduciary website with a buyer identifier to provide the buyer with login access to the single-step ordering system. Further to the step of logging on, there is an additional step of entering a buyer confirmation code.

In accordance with a preferred embodiment of the present invention, a single-step buyer protocol for buying at least one item includes a buyer identifier, a seller identifier, and a transaction identifier for identifying the one or more items to be purchased from the seller. Also included is a single-step buying request issued by the buyer to a fiduciary system to transact an order for one or more items from the seller. The request includes the buyer identifier to facilitate provision of buyer data from a fiduciary database, the seller identifier, and item identifiers for the one or more items. These facilitate the fiduciary system initiating a transaction of a purchase of one or more items from the seller on behalf of the buyer. The protocol also includes a transaction component such that in response to the buying request, the fiduciary initiates the transaction of the one or more items, whereby the fiduciary provides payment to the seller and delivery details in accordance with the buyer identifier.

In accordance with other embodiments of the present invention, in a single-step buyer protocol, the buyer identifier provides the buyer with login access to the fiduciary site. Moreover, the software embodied in the buyer identifier is operative to initiate a request for a buyer confirmation code from the buyer in response to receipt of the buyer identifier by the fiduciary. The single step buyer protocol, further includes the step of checking the authenticity of the seller identifier issued by the buyer.

In accordance with another embodiment of the present invention, in the single-step buyer protocol, the transaction identifier is provided by a browser or other software connected through a public access network.

In accordance with another embodiment of the present invention, in the single-step buyer protocol, the single-step buying-request is initiated by entering a single stroke purchase command.

In accordance with a preferred embodiment of the present invention, a fiduciary system for transacting a purchase of one or more items on behalf of a buyer ensures that the privacy of the buyer is maintained and protected. The system includes a transaction component and a single-step buying component. The buying component comprises a data storage medium for receiving and providing data relevant to a plurality of buyers, such that the privacy of each buyer is preserved and protected. The buying component additionally comprises an order-receiving component for receiving a buying request to transact a purchase of one or more items on behalf of a buyer, in response to a single-step buying request sent by the buyer. A single-step ordering component is included in the buying component to retrieve data from the data storage medium for the buyer so as to facilitate transacting the purchase of the one or more items on behalf of the buyer. The system further includes another transaction component such that in response to the buying request, the fiduciary initiates the transaction of the one or more items, whereby the fiduciary provides payment to the seller and delivery details in accordance with the buyer identifier.

According to an embodiment of the present invention, in the fiduciary system the buying request is sent by a buyer system in response to a single action being performed.

In accordance with a preferred embodiment of the present invention, there is a method for buying one or more items using a single-step buyer system. The method comprises the method steps of identifying the one or more items, disclosing a single-step indicator to be submitted so as to purchase the identified item, and sending the single-step indicator to a fiduciary to buy the at least one identified item on behalf of the buyer, responsive to the single-step indicator. Accordingly, the item is bought independently of the buyer and the purchase is fulfilled while preserving and protecting the privacy of the buyer.

According to an embodiment of the present invention, the method for buying one or more items using a single-step buyer system, including disclosing a single-step indicator, includes the additional step of logging on to a fiduciary web site.

According to an embodiment of the present invention, the method for buying one or more items using a single-step buyer system, including sending the single-step indicator to a fiduciary and also includes identifying additional information needed to generate an order for the item.

According to an embodiment of the present invention, the method for buying one or more items using a single-step buyer system includes the fiduciary system and buyer system communicating via the Internet.

According to an embodiment of the present invention, the method for buying one or more items using a single-step buyer system includes a step of sending a confirmation to the buyer system that the order was generated from the fiduciary system.

According to an embodiment of the present invention, the method for buying one or more items using a single-step buyer system, including the step of sending the single-step indicator, includes the sub-step of entering a single stroke purchase command when a cursor is positioned over a predefined area of displayed information.

According to an embodiment of the present invention, the method for buying one or more items using a single-step buyer system includes the single-step selected from: generating a sound identifier by the buyer, using a television remote control, depressing of a key on a key pad, touching a touch screen, selecting a pointing device or selecting a displayed indication.

According to an embodiment of the present invention, the method for buying one or more items using a single-step buyer system includes disclosing the single-step indicator. This step includes the step selected from: displaying limited information supplied by the fiduciary system as to the identity of the buyer of the buyer system, displaying limited shipping information supplied by the buyer system, displaying limited payment information supplied by the buyer system and displaying an abbreviation for identifying a shipping address for the buyer.

In accordance with one other preferred embodiment of the present invention, there is a method of conducting a point of sale transaction by use of a buyer identifier device, between a buyer, a seller, and a fiduciary, in respect of at least one item to be purchased by the buyer from the seller, whereby the privacy of the buyer is preserved. For a buyer, the method comprises the steps of recording an item identifier and a seller identifier for at least one item, applying the buyer identifier device to a reader device of the seller, thereby to identify the buyer, and sending a purchase request to a fiduciary system to purchase one or more items together with the seller identifier and the sale transaction details.

The method, for a fiduciary system comprises receiving the purchase request and the sale transaction details, retrieving buyer data from a fiduciary database relating to the buyer identifier device, confirming the identity of the buyer in accordance with the buyer identifier device and a buyer identifier code sent by the seller, and authorizing the seller to fill the purchase request received from the buyer in accordance with the sale transaction details, while retaining the confidentiality of buyer specific data contained in the fiduciary database.

According to an embodiment of the present invention, there is a method of conducting a point of sale transaction in which the buyer identifier device is a portable data storage device encoded with predetermined information comprising a buyer code, a buyer password and a fiduciary identifier code.

According to variations of the embodiment of the present invention, there is a method of conducting a point of sale transaction in which the portable data storage device includes a facility to record the seller identifier and the sale transaction details and is password protected.

According to another embodiment of the present invention, there is a method of conducting a point of sale transaction in which the buyer identifier device is a mobile electronic device.

### BRIEF DESCRIPTION OF THE DRAWINGS

The present invention will be more fully understood and appreciated from the following description, taken in conjunction with the drawings, in which:

FIG. 1 is a block diagram representation of a PRIOR ART protocol for effecting a credit card transaction via the Internet;

FIG. 2 is a block diagram representation of a PRIOR ART Internet-based request by a user for a specific service or information from a supplier;

FIG. 3 is a block diagram representation of a secure electronic transaction protocol between a seller and a buyer, in accordance with a preferred embodiment of the present invention;

FIG. 4 is a block diagram representation of an Internet-based secure protocol for submission of a request by a user for a specific service or information from a supplier, in accordance with a further embodiment of the present invention;

FIG. 5 is a block diagram representation of a secure client-based software agent employed in accordance with the present invention, enabling complete user control of information delivered to a supplier via the Internet, in accordance with a further preferred embodiment of the present invention; and

FIG. 6 is a block diagram representation of a user and supplier relationship with a proxy intermediary.

FIG. 7 is a block diagram representation of a fiduciary system for transacting a purchase of one or more items on behalf of a buyer such that the privacy of the buyer is maintained and protected.

FIG. 8 is a block diagram representation of a method of conducting a transaction between a buyer, a seller, and a fiduciary, in respect of at least one item to be purchased by the buyer from the seller wherein a client is not installed on a computer used by the buyer.

FIG. 9 is a block diagram representation of a method of conducting a transaction between a buyer, a seller, and a fiduciary, in respect of at least one item to be purchased by the buyer from the seller by use of a single-step ordering system;

FIG. 10 is a block diagram representation of a method for buying one or more items using a single-step buyer system;

FIG. 11 is a block diagram representation of a single-step buyer protocol for buying one or more items;

FIG. 12 is a block diagram representation of a fiduciary system for transacting a purchase of one or more items on behalf of a buyer such that the privacy of the buyer is maintained and protected;

FIG. 13 is a block diagram representation of a method of conducting a point of sale transaction between a buyer, a seller, and a fiduciary, in respect of at least one item to be purchased by the buyer from the seller; and

FIG. 14 is a block diagram representation of a seller and fiduciary window relating to a point of sale transaction between a buyer, a seller, and a fiduciary.

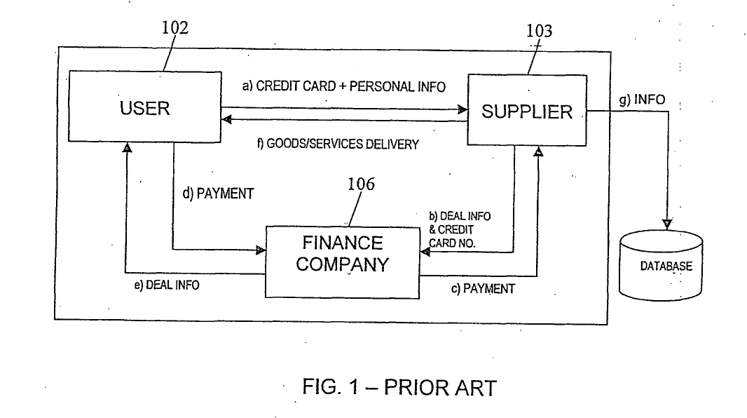

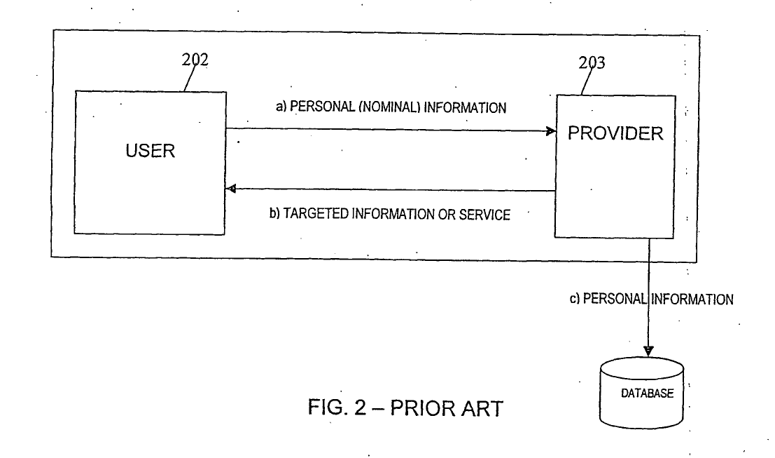

### DETAILED DESCRIPTION OF THE INVENTION

With the growth of Internet commerce, the expected and anticipated level of Internet commercial activity is hampered because Internet users are reticent to give out personal details for fear that these details, having passed beyond the user's control, may be misused. This is true with regard to actual transactions, and also with regard to the provision of any personal information. Giving credit card details to effect payment for an Internet transaction or giving any personal details to receive information or a service is a sacrifice of privacy and also exposes the user to some significant risks. These include fraudulent use of credit card details or at least the provision of personal details to unauthorized parties outside of the required transaction and the loss of control over private personal information. There is a need to provide secure transactions and communication on the Internet and other electronic media while preserving the privacy and reducing the exposure of users.

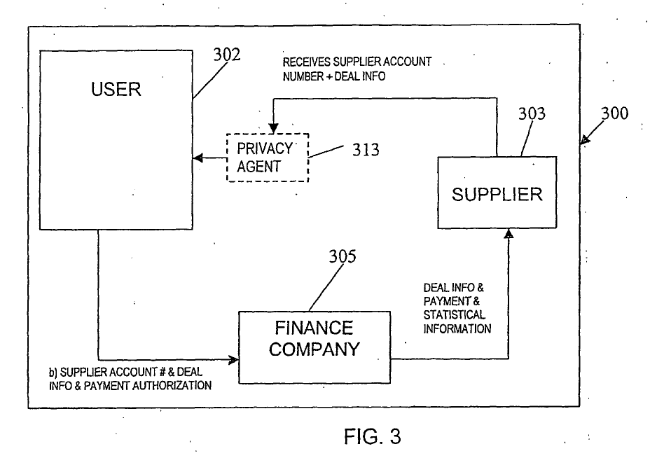

With reference to FIG. 3, in accordance with embodiments of the present invention, there is shown a secure electronic transaction protocol 300 between a seller or supplier 303 offering to sell one or more items, and a user or buyer 302 interested in accepting the offer. Protocol 300 includes the step of a supplier or seller 303 using one or more electronic data-communications media for publishing for a user 302 an offer having a transaction reference identifier linking a price schedule to the one or more items, and a deposit account address of supplier 303. Protocol 300 also includes user 302 sending to a proxy 305 an acceptance-of-the-offer authorization having therein a funds transfer authorization according to the price schedule, the transaction reference identifier and a deposit account address of the supplier 303. The proxy 305 being a fiduciary or finance company, for example, is operative further to receive authorization, and to complete acceptance-of-the-offer by buyer 302 by sending the funds according to the transfer authorization, and the transaction reference identifier, to the deposit account address of supplier 303.

Subsequently, supplier 303 delivers the goods or services to user 302, and user 302 reimburses fiduciary 305.

In the present example, of a monetary transaction, proxy 305 is a fiduciary or any finance company, such as a credit card company, bank, post office or the like.

It will be appreciated by those skilled in the art that the present invention facilitates a secure transaction via the Internet or other electronic media without a user providing any personal information directly or indirectly to a supplier. The transaction has three separate phases using a proxy intermediary to effect payment without presenting the supplier with personal credit card or any other personal banking details of the user, thus avoiding risk of exposure or possible misuse.

When these three phases are complete, the goods are sent by the supplier to the delivery address or to a delivery proxy company for onward delivery to the user.

A comparison of the above-mentioned protocol with the procedure presently utilized to perform so-called secure payments for Internet transactions clearly demonstrates the maintenance of the user's privacy, without disclosure of any private details, both banking and personal, in order to avoid fraudulent use of the buyer's credit card or banking details. Passing the user's personal details to any other party, willingly or accidentally, is also avoided.

According to an embodiment of the present invention, one or more electronic data-communications media such as the Internet, cellular telephone, personal data assistant, terrestrial telephone (POTS), Short Messaging Service (SMS), Wireless Applications Protocol (WAP) is selected. Each of the three phases of the procedure for conveying transaction details as described above can be carried out using any of the media described in the present embodiment. For example, the supplier can provide details to a user as an SMS, the user can advise his bank by email or directly over the Internet and the bank can advise the seller and the buyer by telephone regarding the payment of money into the supplier's account.

Embodiments of the present invention also relate to an empowered credit clearance token, substantially in compliance with the secure electronic commerce protocol, in which a buyer accepts a seller's electronically presented contract offer by executing steps including sending to a fiduciary an acceptance-of-a-seller's-offer authorization including a funds transfer authorization according to a predetermined price schedule, a predetermined transaction reference identifier, and a seller's associated deposit account address.

Referring once again to FIG. 3, in accordance with further embodiments of the present invention there is included a computer program product, illustrated schematically in FIG. 3 as privacy agent 313. Privacy agent 313 includes a computer usable medium having computer readable program code embodied therein for a secure electronic commerce protocol. The computer readable program code in the computer program product 313 includes using at least one electronic data-communications medium on the supplier-side 303 comprising a first computer readable program code for causing a computer to publish for user 302 an offer having therein a transaction reference identifier linking a price schedule to the at least one item; and tied to the first computer readable software, second computer readable program code for causing the computer to publish for a buyer an offer having therein a seller's deposit account address.

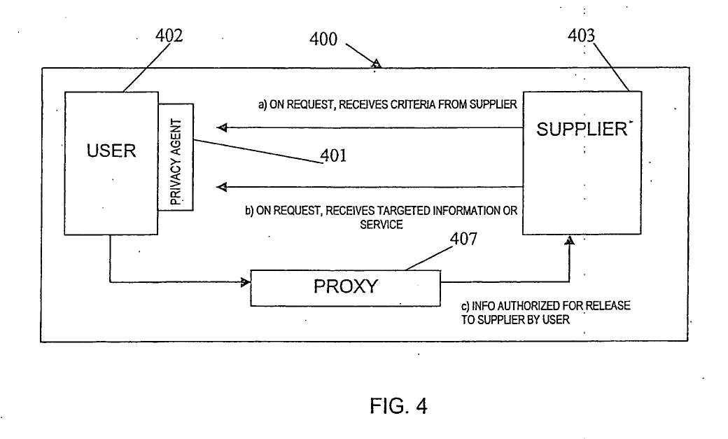

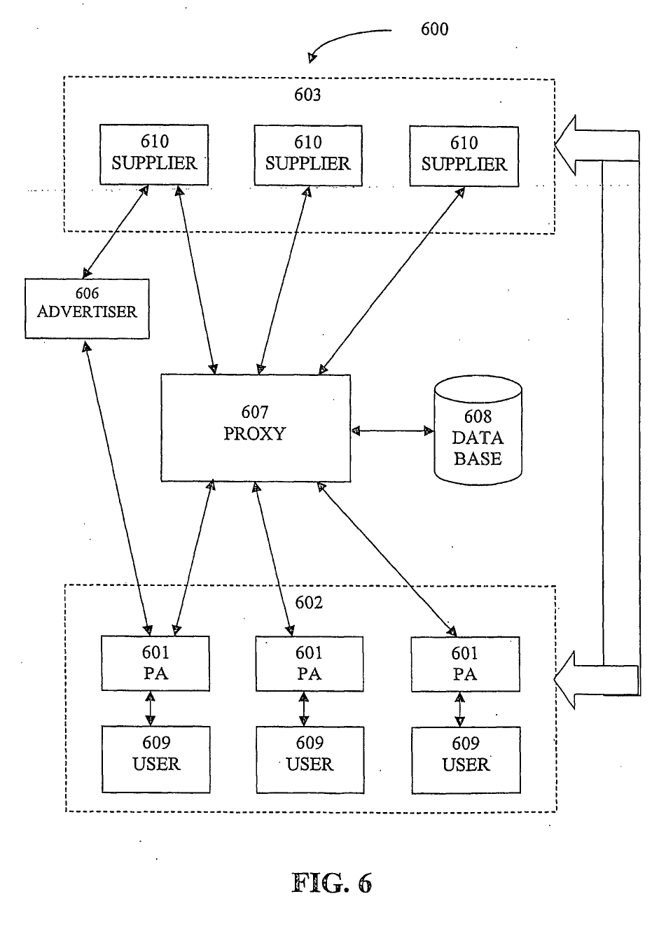

Privacy agent 313 can also advise user 302 vis-a-vis sites and habits of other users having broadly similar profiles to user 302, based on info received from proxy 407 (as disclosed hereinbelow in relation to FIG. 4). Further, via proxy 407, privacy agent 313 can create chat groups or forums. Privacy agent 313 could also enable receipt of advertisements based on user 302 profile. It is significant that proxy 407 belongs not to a particular supplier or group of suppliers but to a third party company (as indicated in FIG. 6).

In terms of the preferred embodiment of the present invention, there is described a new privacy model to secure and to prevent the exposure of user information during the process of Internet transactions between a user and a supplier. Because such exposure is a significant feature of the present model, this has resulted in the failure of E-commerce growth to the extent originally anticipated. In essence, users are generally reticent to give away personal information, which may become subject to misuse, despite their desire to enter into Internet and other electronic media transactions. With regard to the existing model a user wanting to enter into any transaction is presently left with a single option, namely to trust the honesty, integrity, reliability and capability of a supplier.

The preferred embodiment of the present invention seeks to provide a change to this model. The new privacy model presents a user privacy and security by enabling the user to retain all personal information. All nominal personal information on the user-side is maintained as a file on the user's computer or web disk space. Only statistical or non-nominal information is presented to providers or suppliers. As opposed to the model of the present art, the new model is not concerned with user profiles but rather with supplier's profiles. These include decision rules, criterions and other information needed by the user to make data-exchange-dependent actions without giving out user personal or secure information. This means that a user maintains control over personal information and acquires control over that information from a supplier, a sufficient amount of information to carry out a desired transaction.

Referring now to FIG. 4, in accordance with a preferred embodiment of the present invention, there is seen a new model procedure 400 for carrying out interchange of data or acquiring of services required by a user 402 from a supplier 403 via the Internet. Procedure 400 includes the steps:
a privacy agent 401 on user-side 402 requests data or criteria from an Internet site of supplier 403, relating to a sought-after service or information;
if authorized by user 402, privacy agent 401 requests specific services or information from the Internet site of supplier 403, using the supplier's criteria; and
privacy agent 401 provides non-nominal information through a shield server of proxy 407 for onward transmission to the Internet site of supplier 403.

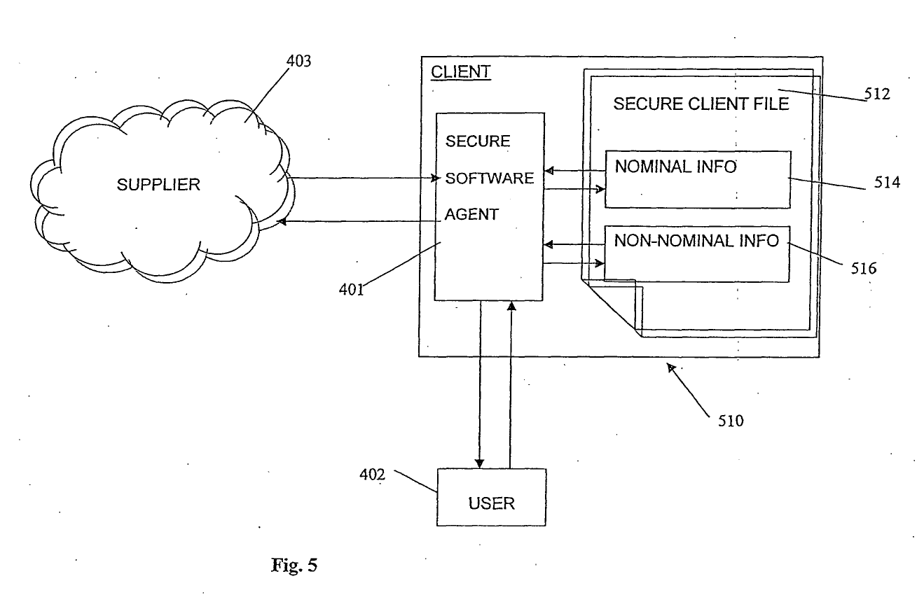

With regard to procedure 400, related hereinabove, and referring now also to FIG. 5, privacy agent 401 is a secure software agent installed in the user's browser, depicted as client 510. Privacy agent 401 builds and manages a secure client file 512. File 512 includes user specific nominal information 514, which includes information by which user 402 may be identified, and user non-nominal information 516, which includes information pertaining to the user 402, but by which the user could not be easily identified. As the need arises, the privacy agent 401 requests additional data from user 402, coding this added information into the user 402 personal file. While this encoded information, in the form of secure client file 512, is preferably stored in a client-located medium, such as on a magnetic or optical storage medium located on the computer of user 402, it may alternatively be on a remote server accessed via a network.

Preferably, privacy agent 401 is further operable so as to request or pull criteria data from Internet sites, to carry out calculations with data for user 402, and then to pull the information or service that fits the profile of user 402 from the Internet site offering the information or service. However, by default, privacy agent 401 only pushes non-nominal information to sites that have a specific need. In the event that any nominal or other information predefined as highly personal is requested, this will only be provided at the express authorization of the user 402.

With regard to the embodiment of the present invention in relation to FIG. 3, it will be understood by those skilled in the art that privacy agent 401 pulls supplier 403 deposit account details from the supplier 403 web-site, when the need arises to effect payment to a supplier for Internet credit card transactions. Thereafter, privacy agent 401 communicates with the user 402 credit card company's server 407 to transmit payment to supplier 403. Additionally, privacy agent 401 is able to recommend to user 402 those web-sites offering required commodities or services that follow user 402 profile.

Referring now to FIG. 6, there is seen a relationship, generally referenced 600, between a group 602 of a plurality of users 609 and a group 603 of a plurality of suppliers 610. Communication by one or more users 609 in response, for example, to an advertiser 606 is through communication with a privacy agent 601 to a proxy server 607. Proxy server 607, in turn, communicates the need or payment of one or more of users 609 for information, services or goods, to one or more of suppliers 610. Proxy server 607 accumulates nominal and non-nominal data in a database 608, relating to users 609 to facilitate transactions on behalf of users 609 and on their behalf by privacy agents 601. Proxy 607 only releases nominal data to suppliers 610 as required by each user 609. Payments from each user 609 to each supplier 610 may be transacted by proxy 607 on a consolidated basis and not necessarily on a single transaction basis.

Furthermore, the secure electronic commerce protocol in which sending a funds-transfer authorization to the fiduciary includes authorizing preselected partial payments over a preselected time period. This is facilitated by in accordance with a code issued by the fiduciary's side, such that the code includes one or more of the following identifiers, namely a seller identifier a buyer identifier, preselected partial payment amount, preselected time period for payment or individual payment identifiers.

Additionally, the code includes preselected code characters, which indicate predetermined information, such as the payment number of the current payment due, the number of outstanding payments, payment time limit and the amount outstanding.

Also, sending a funds transfer authorization to the fiduciary includes authorizing a time limitation for the transfer of funds in accordance with a code issued by the fiduciary's side, such that the code includes one or more identifier for the seller, buyer, the preselected partial payment amount, preselected time period for payment and an individual payment identifier.

The system, according to embodiments of the present invention, can perform a repeated, continuing payments by providing a special code that can be used more then once. Such a code can be, for example “SFFG56DFTER234—6” This means six payments are due. The merchant will be able to collect the first payment with this code, the second with “SFFG56DFTER234—5” and so on. A time-limited code can be, for example, “SFFG56DFTER234—10/2002M-500$” and can be used in this example until October 2002 to collect monthly (M) payments less then 500$ each and so on. Because these codes are produced by the fiduciary or Credit Company, each can by checked to ensure their proper use and by the correct merchant only.

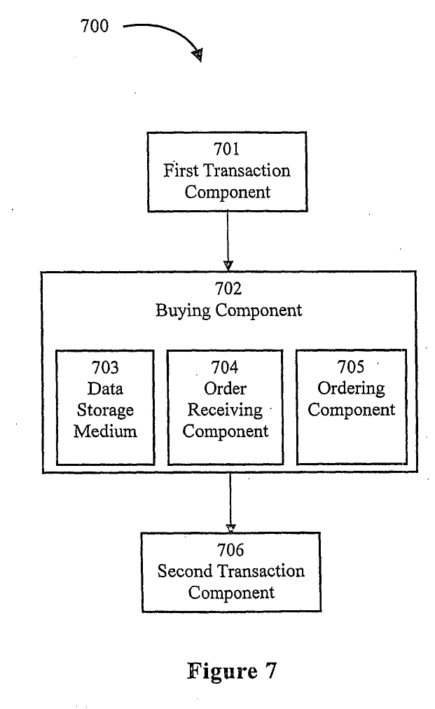

Referring now to FIG. 7, there is seen a fiduciary system 700 for transacting a purchase of one or more items on behalf of a buyer such that the privacy of the buyer is maintained and protected. System 700 comprises a first transaction component 701 and a buying component 702.

Buying component 702 includes a data storage medium 703 for receiving and providing data relevant to a plurality of buyers, such that the privacy of each buyer is preserved and protected. Buying component 702 further includes an order receiving component 704 for receiving a buying request to transact a purchase of one or more items on behalf of a buyer, in response to a buying request sent by the buyer. There is also included an ordering component 705 to retrieve data from data storage medium 703 for the buyer so as to facilitate transacting the purchase of the at least one item on behalf of the buyer.

System 700 also includes a second transaction component 706, such that, in response to the buying request, the fiduciary initiates the transaction relating to the one or more items. The fiduciary thereupon provides to the seller payment and predetermined information, including shipping details, quantity of items ordered, delivery address or packaging specification. The buying request may be initiated by application of a buyer identification device, having software embodied therein, to a secure login reader connected to a public access network. Furthermore, the buying request is sent by a buyer system to a fiduciary system in response to at least one action being performed by the buyer system.

Should a seller site not include access to the fiduciary system (as disclosed hereinabove in relation to FIG. 7), the user selects the required items to be purchased from the seller site. Thereupon, the user enters the secure site of a fiduciary site, such as a credit card company or other fiduciary or uses a link thereto, if available. Details of the intended transaction and seller are conveyed to the secure site so as to facilitate the completion of a user-protected transaction.

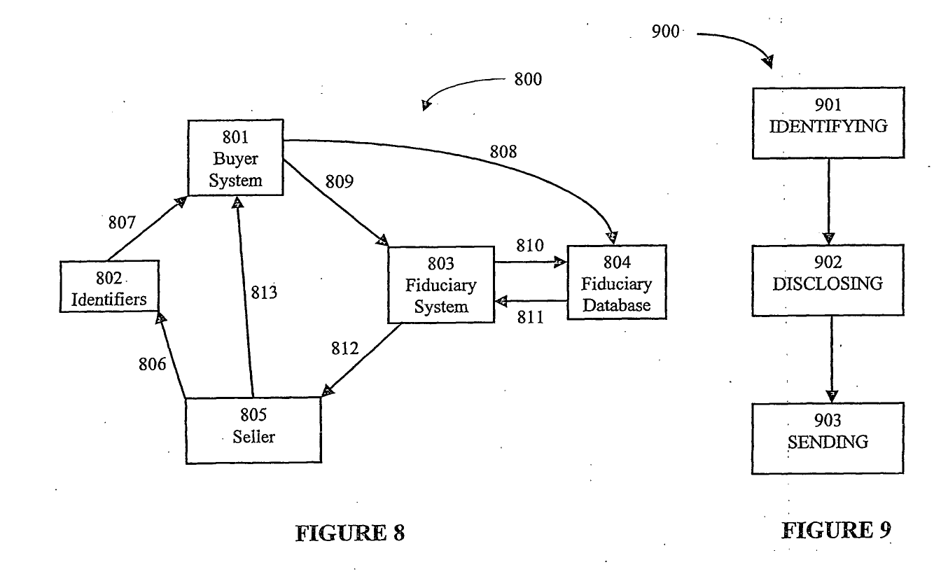

Referring now to FIG. 8 there is seen a block diagram representation of a method 800 of conducting a transaction between a buyer 801, a seller (not shown), and a fiduciary 805, in respect of one or more items to be purchased by buyer 801 from the seller. The privacy of the buyer is preserved, despite the fact that a client is not installed on a computer used by buyer 801 for the transaction. Method 800 includes the steps for buyer 801 of recording 802 an item identifier and a seller identifier for one or more items, logging 803 on to secure fiduciary site 805 and sending 804 a purchase request to the fiduciary site to purchase the one or more items together with the item identifier and the seller identifier.

For fiduciary system 805, method 800 includes the steps of receiving 806 the purchase request, retrieving 807 buyer data from a fiduciary database relating to a buyer identifier, confirming 808 the identity of the buyer, opening 809 the seller's payment form and authorizing 810 the seller to fill the purchase request received from the buyer, while retaining the confidentiality of buyer specific data contained in the fiduciary database.

Method 800 for transmitting secure data without installing a client is necessitated when the surfer or buyer 801 wants to make a purchase away from his secure system and needs a secure login. That can be performed only at a trusted site like the site of a fiduciary 805 such as a Credit Card Company. When the surfer 801 decides to make a purchase he simply enters the Credit Card Company's web address on the browser (or uses a link) and serfs away from the merchant's purchasing form to the secure Credit Card Company's site 805 and securely logs in. Then the secure site performs a check to see where from the surfer came, and opens the merchant's payment form as a frame on it's own page. Any required information can be taken from merchant's page to perform the secure payment process, including inserting the needed information on the merchant's page if it does not support method 800 technology.

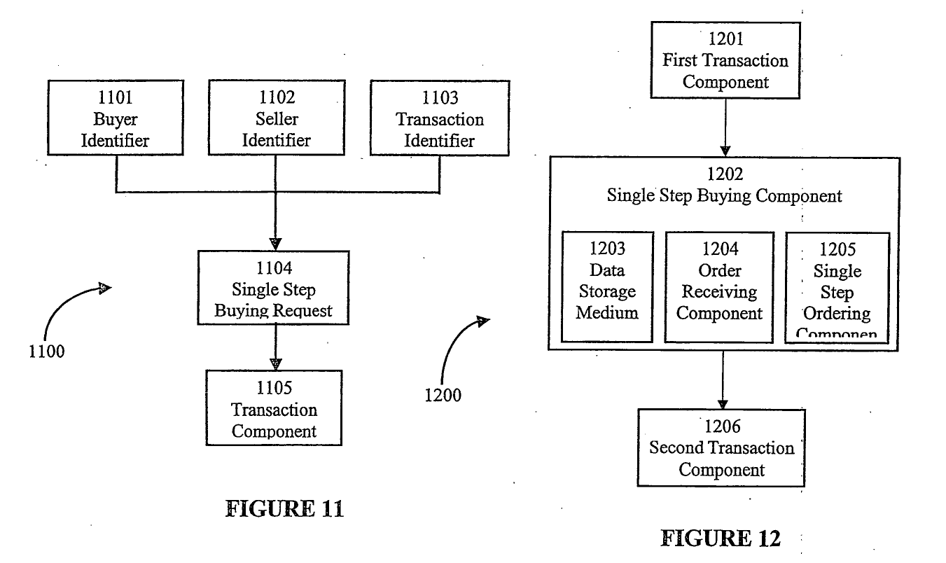

Referring now to FIG. 9, in accordance with another embodiment of the present invention, there is seen a block diagram representing a method 900 for conducting a transaction, such as placing an order for one or more items using a single-step ordering system (disclosed in relation to FIGS. 11 and 12 hereinbelow), whereby the privacy of a buyer is preserved and protected. Method 900 comprises steps, for a buyer system, of recording 907 an item and seller identifier 902 for one or more items, and sending 909 a single-step request to a fiduciary system 903 to purchase one or more items together with item and seller identifiers 902 which were provided 906 by seller 905.

For a single-step fiduciary system 903, method 900 includes the steps of receiving 909 the request, retrieving 910 and 911 data from a fiduciary database 904 relating to the buyer identifier provided 908 by buyer system 901 to fiduciary database 904, creating an order to purchase the one or more item in the received request on behalf of the buyer 901 identified by the buyer identifier using the retrieved 911 buyer data, and transacting 912 the order to complete purchase of the one or more items. In terms of method 900, the one or more items are ordered while preserving the privacy of the buyer.

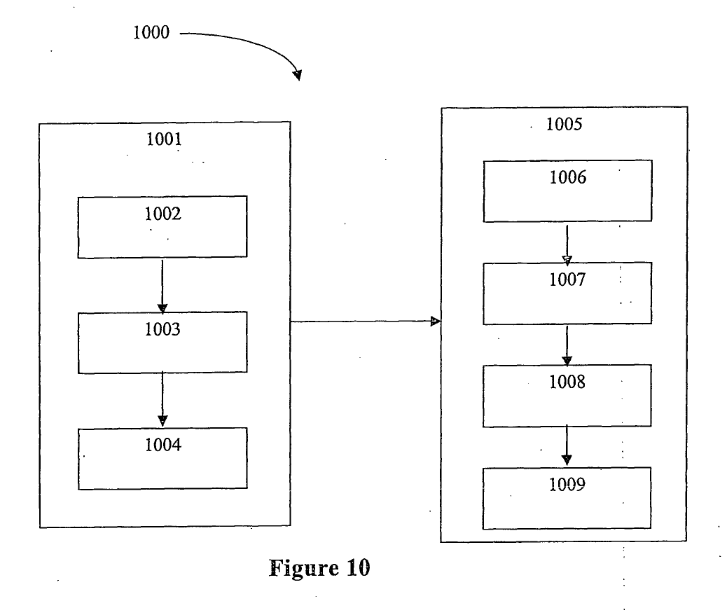

Referring now to FIG. 10, in accordance with an added embodiment of the present invention, there is illustrated a block diagram illustrating a method 1000 for buying an at least one item using a single-step buyer system. Method 1000 comprises method steps of identifying 1001 one or more items, disclosing 1002 a single-step indicator to be submitted so as to purchase the identified item; and sending 1003 the single-step indicator to a fiduciary to buy one or more identified items on behalf of the buyer, responsive to the single-step indicator. Method 1000 facilitates the actual buying of the item independently of the buyer and the purchase is fulfilled while preserving and protecting the privacy of the buyer.

Referring now to FIG. 11, in accordance with a further embodiment of the present invention, there is seen a block diagram illustrating a secure electronic commerce protocol 1100 for buying one or more items. Protocol 1100 includes a buyer identifier 1101, which defines an identity for a buyer without disclosing private details regarded by the buyer as confidential in relation to a seller. In addition, protocol 1100 includes a seller identifier 1102, which provides banking details regarding the seller so as to facilitate payment to the seller by a fiduciary on behalf of the buyer. Also included is a transaction identifier 1103 for identifying one or more items to be purchased from the seller.

Further, protocol 1100 includes a single-step buying request 1104, which is issued by the buyer to a fiduciary system to transact an order of one or more items from the seller, the request including buyer identifier 1101 to facilitate provision of buyer data from a fiduciary database, seller identifier 1102 and transaction identifiers 1103 for one or more items, such that the fiduciary system initiates transaction of a purchase of the one or more items from the seller on behalf of the buyer. Protocol 1100 further includes a transaction component 1105 such that, in response to the buying request, the fiduciary initiates the transaction of the one or more items, whereby the fiduciary provides payment to the seller and delivery details in accordance with the buyer identifier.

Referring now to FIG. 12, in accordance with another embodiment of the present invention, there is seen a block diagram illustrating a fiduciary system 1200 for transacting a purchase of at least one item on behalf of a buyer such that the privacy of the buyer is maintained and protected. System 1200 includes a first transaction component 1201, which relates to a transaction decision by a buyer to make a purchase.

System 1200 also includes a single-step buying component 1202, comprising a data storage medium 1203 for receiving and providing data relevant to a plurality of buyers, such that the privacy of each buyer is preserved and protected; an order receiving component 1204 for receiving a buying request to transact a purchase of at least one item on behalf of a buyer, in response to a single-step buying request sent by the buyer; and a single-step ordering component 1205 to retrieve data from the data storage medium for the buyer so as to facilitate transacting the purchase of one or more items on behalf of the buyer.

System 1200 further includes a second transaction component 1206 such that in response to the buying request, the fiduciary initiates the transaction of one or more items, whereby the fiduciary provides payment to the seller and delivery details in accordance with the buyer identifier.

Simply stated, the user logs into the one-step secure electronic protocol system at any time prior to, while or after starting the browser. The system may also be initiated at the time of deciding to utilize the one-step system. Should a seller site support the one-step system, specifically initiating logging into the system will be unnecessary, as the seller site will recognize the buyer as a subscriber to the system and provides the buyer with an operational symbol or button. By using this one-click button, the buyer initiates a purchase of one or more items on offer.

There are two alternative examples of options for implementation of protocol 1100 and system 1200.

The first option includes:

Step 1: User logs into the system. This can be done before, when or after starting the browser or after reaching a shopping site, or after deciding to initiate the one-click method upon being required by a site for such an option, or if the system recognizes that the site supports protocol 1100 functionality and process.

Step 2: The site recognizes that the one click system is available and makes a button operational to initiate the purchase.

Step 3: The user buys a product represented by pressing the button on the site.

Other security features may be incorporated, such as automatic log-out if too much time had passed, or if the computer had been in active for too long, or a warning sign “You are in one-click mode” is turned on, and other user-defined options. The user may also be notified after a one-click purchase has been made about the purchase and possible actions for canceling it.

In relation to the second option, this method can perform a one-click sale on sites that do not supports the method that was described above in relation to the first option. Merchant's site can contain agreed information about the location of the purchasing web page form, or such location can be located by the system by using conventional analysis of the site. Then the surfer selects an item for purchasing this can by detected by the client by analyzing the text on the button, for example. Then the client can secretly open the purchasing form to get the purchase details and perform the secure payment hidden from the view of the surfer.

Thereupon, all information regarding the intended purchase is conveyed to the fiduciary, which immediately confirms the transaction with the seller on behalf of the buyer and arranges direct payment into the bank account of the seller.

Additional security features may be incorporated into the system. These features include an automatic time-out innovation and a log-out feature when the system has been inactive for more than a predetermined period. Furthermore, the user may be informed that the transaction is about to be concluded, thereby giving the user an opportunity to cancel the transaction.

There are additional innovations, in accordance with other embodiments of the present invention. The one-step system (referred to hereinabove in relation to FIGS. 9-12), is provided with a facility for the credit card company or other fiduciary to make part-payments over a preselected payment period. A suitable payment code is included with the user's instruction contained in a purchasing indicator to the fiduciary, which code specifies each part-payment and the date thereof. A further innovation enables the user to specify a maximum payment amount and a payment frequency.

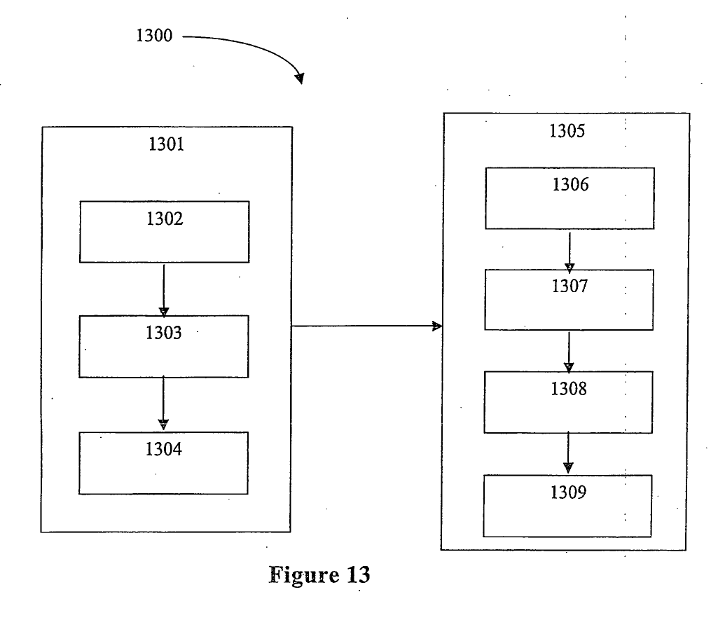

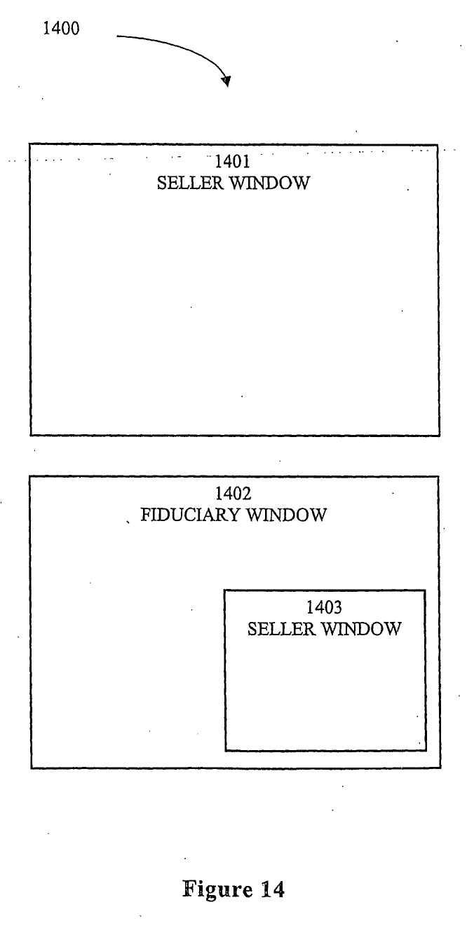

In accordance with another preferred embodiment of the present invention, referring now to FIGS. 13 and 14, there is illustrated the steps of a method 1300 of conducting a point of sale transaction by use of a buyer identifier device, between a buyer 1301, a seller (not shown), and a fiduciary 1305. Method 1300 is in respect of one or more items to be purchased by the buyer 1301 from the seller, whereby the privacy of the buyer is preserved.

Method 1300 comprises, for a buyer, steps of recording 1302 an item identifier and a seller identifier for at least one item, applying 1303 the buyer identifier device to a reader device of the seller, thereby to identify the buyer, and sending 1304 a purchase request to a fiduciary system 1305 to purchase the one or more items together with the seller identifier and the sale transaction details.

Method 1300 comprises, for a fiduciary system 1305, steps of receiving 1306 the purchase request and the sale transaction details, retrieving 1307 buyer data from a fiduciary database relating to the buyer identifier device, confirming 1308 the identity of the buyer in accordance with the buyer identifier device and a buyer identifier code sent by the seller, and authorizing 1309 the seller to fill the purchase request received from the buyer in accordance with the sale transaction details, while retaining the confidentiality of buyer specific data contained in the fiduciary database.

As indicated in FIG. 14, there is seen a window system 1400, indicating the seller's window 1401 as it appears to the buyer, on initiating the point of sale purchase, displaying the seller's banking and other relevant details. After the buyer identifier device such as a smart card or other similar device has been presented to the seller and the identity of the buyer has been confirmed by the fiduciary, the seller's window 1403 now appears in the fiduciary window 1402, facilitating the capture of the seller's banking and other necessary details by the fiduciary, so as to facilitate payment by the fiduciary to the seller for the chosen one or more items, without revealing any personal information concerning the buyer.

The buyer identifier device is a portable data storage device such as a smart card or compact disc, encoded with predetermined information such as a buyer code, a buyer password or fiduciary identifier code and may include a facility to record the seller identifier and the sale transaction details. The portable data storage device may also be password protected. Also, the buyer identifier device may be a mobile electronic device.

In the case of a smart card, which contains buyers code, buyers password, encryption code of fiduciary, and ability (directly or via external processor), when swiped at a point of sale (e.g. check out in a store, gas station, etc.) to receive the seller's code and details of payment to be made for a specific transaction. The details are encoded into a file, which is provided by the seller to the fiduciary.

The point of sale purchasing technology includes, for example, a “smart card” in which is embedded a chip on which the system technology had been installed. The system is “initialized” by the user. This initialization would make any unauthorized usage, identified by incorrect password entered more than a preselected number times, lock the system from the user and make the card unusable.

The card would not have any identifying account information details. It may not have even the user name on it, just the issuer and fiduciary or credit card association names. When a user wants to conduct a card presenting transaction, the card is inserted to a special reader connected to a screen and to a public access network connection. The system starts and requests the user to enter a password. The user enters it and the system processes the transaction. Purchase details are presented before or after the purchase and the user may be asked for further authorization for purchase irrespective of the validity of the password. This has the advantage of reducing card-present fraud to minimal levels since both the card and the password, which is encrypted inside the module on the card, must be stolen in order for fraud to be conducted. Furthermore, as mentioned hereinabove, if the wrong password is used for more than a preselected number of times, the module gets locked out or erases itself, rendering the card useless. Privacy is maintained since the card is practically a blank card without personal details unless the user requests otherwise, such as for a name to appear on the card.

Similarly to the “smart card” option mentioned hereinabove, a mobile electronic device may be used to connect to the merchant systems, either via a port of a wireless connection. The mobile device carries the module and a transaction takes place as as related hereinabove.

In accordance with other embodiments of the present invention, access to the fiduciary system, is provided by the use of a so-called “smart card”. This card includes a facility, such as a specifically embedded chip, to utilize the user protected system or protocol. The user is provided With a secure login reader. Before the user enters into a transaction, the smart card is inserted into the reader to log into the fiduciary site, and, upon demand, the user enters a password or other recognition data. Failure to correctly enter the requisite data within a predetermined number of attempts or within a specified time renders the smart card locked-off until the issuing company renews or re-issues the card. After the user correctly supplies the requisite data, the fiduciary determines the details of the transaction and of the seller in order to complete the transaction, generally as disclosed hereinabove. The smart card has the advantage of reducing instances of fraudulent card usage. User privacy is maintained since the card retains no specific personal data concerning the user.

It will be appreciated by persons skilled in the art that the present invention relates not only to purchase of goods or services but also to transfer of information without necessarily including a financial transaction. Other transactions facilitated by embodiments of the present invention include, for example, registering for subscription to on-line journals. The present invention provides a procedure, which is the reverse of that in current use. The supplier, instead of the user, provides necessary nominal information to the user or to a proxy of the user, thereby conserving the privacy of the user.

Furthermore, in accordance with embodiments of the present invention, it is stressed that the present invention relates specifically to user privacy in respect of provision of goods, services and information, even when money does not change hands in the course of a transaction.

It will be appreciated by persons skilled in the art that the system, protocol, product and devices of the present invention include utilizing encryption methodologies for further protecting information and transmissions of such information. Furthermore, additional or different verification processes and systems may also be used. However, such systems and processes constitute embodiments of the present invention and do not in any way change the fundamental nature of the present invention as shown and described hereinabove.

It will be appreciated by persons skilled in the art that the present invention is not limited solely to that shown and described hereinabove by way of example. Rather, the scope of the present invention is limited solely by the claims, which follow:

1. A secure electronic commerce protocol for use between on the one hand a seller offering to sell at least one item and on the other hand a buyer interested in accepting the offer and thereby buying at least one item offered for sale by the seller, and the protocol includes the steps of: using at least one electronic data-communications media:
a) on the seller's side, publishing for a buyer an offer having therein
i) a transaction reference identifier linking a price schedule to the at least one item, and
ii) a seller's deposit account address;
b) on the buyer's side, sending to a fiduciary an acceptance-of-the-offer authorization having therein
i) a funds-transfer authorization according to the price schedule,
ii) the transaction reference identifier and
iii) the seller's deposit account address; and
c) on the fiduciary's side, receiving the authorization, and completing the buyer's acceptance-of-the-offer by sending to the seller's deposit account address
i) the funds according to the transfer authorization, and
ii) the transaction reference identifier.

2. A secure electronic commerce protocol according to claim 1 wherein a media of the at least one electronic data-communications media is selected from the list: Public access network, cellular telephone, personal data assistant, terrestrial telephone (POTS), Short Messaging Service (SMS), or Wireless Applications Protocol (WAP).

3. An empowered credit clearance token, substantially in compliance with the secure electronic commerce protocol according to claim 1, wherein a buyer accepts a seller's electronically presented contract offer by executing steps including sending to a fiduciary an acceptance-of-a-seller's-offer authorization having therein:
a) a funds transfer authorization according to a predetermined price schedule;
b) a predetermined transaction reference identifier; and
c) a seller's associated deposit account address.

4. A secure electronic commerce protocol according to claim 1 wherein the buyer's side is empowered by an authorized buyer search agent.

5. A secure electronic commerce protocol according to claim 1 wherein the seller's side is empowered by an authorized seller presentation agent.

6. A secure electronic commerce protocol according to claim 1 wherein the buyer's side and the fiduciary side constitute a single entity thereby facilitating direct buyer acceptance of the seller's offer.

7. A secure electronic commerce protocol according to claim 1 wherein the at least one item is selected from a list of goods or services or information.

8. A secure electronic commerce protocol according to claim 1 wherein completing the buyer's acceptance-of-the-offer includes the fiduciary's side receiving from the seller's side a purchase order receipt or a work order receipt or a contract closure confirmation receipt.

9. A secure electronic commerce protocol according to claim 1 wherein completing the buyer's acceptance-of-the-offer includes the buyer's side receiving from the seller's side a purchase order receipt or a work order receipt or a contract closure confirmation receipt.

10. A secure electronic commerce protocol according to claim 1 wherein completing the buyer's acceptance-of-the-offer includes the buyer's side receiving from the fiduciary's side a purchase order receipt or a work order receipt or a contract closure confirmation receipt.

11. A secure electronic commerce protocol according to claim 1 wherein the seller's side is an intelligent agent.

12. A secure electronic commerce protocol according to claim 1 wherein the buyer's side is an intelligent agent.

13. A secure electronic commerce protocol according to claim 1 wherein the fiduciary's side is an intelligent agent.

14 A secure electronic commerce protocol according to claim 1 wherein the identity of the buyer's side is maintained in confidentiality by the fiduciary's side, thereby preserving anonymity of the buyer's side from the seller's side.

15. A secure electronic commerce protocol according to claim 1 wherein publishing includes an extended markup language (XML) descriptor.

16. A secure electronic commerce protocol according to claim 1 wherein the seller's side is server resident.

17. A secure electronic commerce protocol according to claim 1 wherein the buyer's side is server resident.

18. A secure electronic commerce protocol according to claim 1 wherein the fiduciary's side is server resident.

19. A computer program product including a computer usable medium having computer readable program code embodied therein for a secure electronic commerce protocol, the computer readable program code in said computer program product including: using at least one electronic data-communications media on the seller's side,
a) first computer readable program code for causing a computer to publish for a buyer an offer having therein a transaction reference identifier linking a price schedule to the at least one item; and
b) tied to the first computer readable software, second computer readable program code for causing the computer to publish for a buyer an offer having therein a seller's deposit account address.

20. A computer program product including a computer usable medium having computer readable program code embodied therein for a secure electronic commerce protocol, the computer readable program code in said computer program product including: using at least one electronic data-communications media on the buyer's side,
a) first computer readable program code for causing a computer to send to a fiduciary an acceptance-of-the-offer authorization having therein a finds transfer authorization according to the price schedule;
b) tied to the first computer readable software, second computer readable program code for causing the computer to send to a fiduciary an acceptance-of-the-offer authorization having therein the transaction reference identifier; and
c) tied to the second computer readable software, third computer readable program code for causing the computer to send to a fiduciary an acceptance-of-the-offer authorization having therein the seller's deposit account address.

21. A computer program product including a computer usable medium having computer readable program code embodied therein for a secure electronic commerce protocol, the computer readable program code in said computer program product including: using at least one electronic data-communications media on the fiduciary's side,
a) first computer readable program code for causing a computer to receive the authorization and to complete the buyer's acceptance-of-the-offer by sending to the seller's deposit account address the funds according to the transfer authorization; and
b) tied to the first computer readable software, second computer readable program code for causing the computer to receive the authorization, and complete the buyer's acceptance-of-the-offer by sending to the seller's deposit account address the transaction reference identifier.

22. A program storage device readable by machine, tangibly embodying a program of instructions executable by the machine to perform method steps for a secure electronic commerce protocol, said method steps including: using at least one electronic data-communications media on the seller's side, publishing for a buyer an offer having therein
a) a transaction reference identifier linking a price schedule to the at least one item; and
b) a seller's deposit account address.

23. A program storage device readable by machine, tangibly embodying a program of instructions executable by the machine to perform method steps for a secure electronic commerce protocol, said method steps including: using at least one electronic data-communications media, on the buyer's side sending to a fiduciary an acceptance of an offer authorization having therein:
a) a funds transfer authorization according to the price schedule;
b) a transaction reference identifier; and
c) a seller's deposit account address.

24. A program storage device readable by machine, tangibly embodying a program of instructions executable by the machine to perform method steps for a secure electronic commerce protocol, said method steps including: using at least one electronic data-communications media on the fiduciary's side, receiving the authorization, and completing the buyer's acceptance-of-the-offer by sending to the seller's deposit account address,
a) funds according to a transfer authorization; and
b) a transaction reference identifier; and
c) a seller's deposit account address.

25. An agent, embodied in software resident in a machine-readable device, for facilitating a secure transaction between a user and an entity, with which the user may seek to interact, said agent including:
means for receiving from an Internet browser used by a user, nominal and non-nominal information associated with the user;
means for storing the information in a user file, so as to construct a user profile;
means for receiving transaction rules from a remote entity with whom the user may seek to interact;
means for determining the relevance of the transaction rules to the user profile; and
means for sending selected information associated with the user, to the remote entity, in accordance with the transaction rules received therefrom.

26. A secure electronic commerce protocol according to claim 1 wherein sending a funds transfer authorization to the fiduciary includes authorizing preselected partial payments over a preselected time period.

27. A secure electronic commerce protocol according to claim 26 wherein authorizing preselected partial payments over a preselected time period in accordance with a code issued by the fiduciary's side, such that the code includes at least one identifier selected from the group comprising:
a) seller identifier;
b) buyer identifier;
c) preselected partial payment amount;
d) preselected time period for payment; and
e) individual payment identifier.

28. A secure electronic commerce protocol according to claim 27 wherein the code includes preselected code characters which indicate predetermined information, including information selected from the group comprising
a) payment number of current payment due;
b) number of outstanding payments;
c) payment time limit; and
d) amount outstanding.

29. A secure electronic commerce protocol according to claim 26 wherein sending a funds transfer authorization to the fiduciary includes authorizing a time limitation for the transfer of funds in accordance with a code issued by the fiduciary's side, such that the code includes at least one identifier selected from the group comprising:
a) seller identifier;
b) buyer identifier;
c) preselected partial payment amount;
d) preselected time period for payment; and
e) individual payment identifier.

30. A fiduciary system for transacting a purchase of at least one item on behalf of a buyer such that the privacy of the buyer is maintained and protected, the system comprising:
a) a first transaction component;
b) a buying component including:
i) a data storage medium for receiving and providing data relevant to a plurality of buyers, such that the privacy of each buyer is preserved and protected,
ii) an order receiving component for receiving a buying request to transact a purchase of at least one item on behalf of a buyer, in response to a buying request sent by the buyer, and
iii) an ordering component to retrieve data from the data storage medium for the buyer so as to facilitate transacting the purchase of the at least one item on behalf of the buyer; and
c) a second transaction component, such that, in response to the buying request, the fiduciary initiates the transaction relating to the at least one item, whereby the fiduciary provides to the seller payment and predetermined information, including at least information selected from the group comprising:
i) shipping details;
ii) quantity of items ordered;
iii) delivery address; and
iv) packaging specification.

31. The fiduciary system according to claim 30 wherein the buying request is initiated by application of a buyer identification device, having software embodied therein, to a secure login reader connected to a public access network.

32. The fiduciary system according to claim 30 wherein the buying request is sent by a buyer system to a fiduciary system in response to at least one action being performed by the buyer system.

33. A method of conducting a transaction between a buyer, a seller, and a fiduciary, in respect of at least one item to be purchased by the buyer from the seller whereby the privacy of the buyer is preserved, and wherein a client is not installed on a computer used by the buyer for the transaction, said method includes the steps of
a) for the buyer
i) recording an item identifier and a seller identifier for at least one item,
ii) logging on to a secure fiduciary site, and
iii) sending a purchase request to the fiduciary site to purchase the at least one item together with the item identifier and the seller identifier; and
b) for a fiduciary system
i) receiving the purchase request,
ii) retrieving buyer data from a fiduciary database relating to a buyer identifier,
iii) confirming the identity of the buyer,
iii) opening the seller's payment form; and
iv) authorizing the seller to fill the purchase request received from the buyer, while retaining the confidentiality of buyer specific data contained in the fiduciary database.

34. A method of conducting a transaction between a buyer, a seller, and a fiduciary, in respect of at least one item to be purchased by the buyer from the seller by use of a single-step ordering system, whereby the privacy of the buyer is preserved, said method comprising:
a) for a buyer system,
i) recording an item identifier and a seller identifier for at least one item, and
ii) sending a purchase request to a fiduciary system to purchase the at least one item together with the item identifier and the seller identifier; and
b) for a fiduciary system
i) receiving the purchase request,
ii) retrieving buyer data from a fiduciary database relating to a buyer identifier, and
iii) authorizing the seller to fill the purchase request received from the buyer, while retaining the confidentiality of buyer specific data contained in the fiduciary database.

35. A method according to claim 34 wherein said buyer data includes at least predetermined information selected from the group comprising
a) shipping details;
b) quantity of items ordered;
c) delivery address; and
d) packaging specification.

36. A method according to claim 34 wherein said step a)i) of recording an item identifier and a seller identifier includes the sub-step of displaying information to the buyer indicating details of the item identifier and seller identifier.

37. A method according to claim 34 wherein said step a)ii) of sending a purchase request includes the sub-step of entering a single touch purchase command when a cursor is positioned over a predefined area of displayed information.

38. A method according to claim 34 wherein said step a)ii) of sending a purchase request includes the sub-step of generating an identification sound signal by the buyer.

39. A method according to claim 34, and further including, prior to said step a)ii) of sending a purchase request, the additional step of logging on to a fiduciary website so as to provide the buyer with access to the single-step ordering system.

40. A method according to claim 34 wherein said additional step of logging on includes the additional step of entering a buyer confirmation code.

41. A single step buyer protocol for buying at least one item which comprises:
a) a buyer identifier;
b) a seller identifier;
c) a transaction identifier for identifying the at least one item to be purchased from the seller;
d) a single-step buying request issued by the buyer to a fiduciary system to transact an order of the at least one item from the seller, the request including the buyer identifier to facilitate provision of buyer data from a fiduciary database, the seller identifier and item identifiers for the at least one item, such that the fiduciary system initiates transaction of a purchase of the at least one item from the seller on behalf of the buyer; and
e) a transaction component, such that, in response to the buying request, the fiduciary initiates the transaction of the at least one item, whereby the fiduciary provides payment to the seller and predetermined information, including information selected from the group comprising:
i) shipping details,
ii) quantity of items ordered,
iii) delivery address, and
iv) packaging specification.

42. The single step buyer protocol according to claim 41, further including the step of checking the authenticity of the seller identifier issued by the buyer.

43. The single step buyer protocol of claim 41 wherein the buyer identifier accrued to the embodied software provides the buyer with log in access to the fiduciary site.

44. The single step buyer protocol of claim 41 wherein the transaction identifier is provided by a browser or other software connected through a public access network.

45. The single step buyer protocol of claim 41 wherein the single step buying request is initiated by entering a single stroke purchase command.

46. A fiduciary system for transacting a single step purchase of at least one item on behalf of a buyer such that the privacy of the buyer is maintained and protected, the system comprising:
a) a first transaction component;
b) a single-step buying component including:
i) a data storage medium for receiving and providing data relevant to a plurality of buyers, such that the privacy of each buyer is preserved and protected,
ii) an order receiving component for receiving a buying request to transact a purchase of at least one item on behalf of a buyer, in response to a single-step buying request sent by the buyer, and
iii) a single-step ordering component to retrieve data from the data storage medium for the buyer so as to facilitate transacting the purchase of the at least one item on behalf of the buyer; and
c) a second transaction component such that in response to the buying request, the fiduciary initiates the transaction of the at least one item, whereby the fiduciary provides payment to the seller and delivery details in accordance with the buyer identifier.

47. The fiduciary system according to claim 46 wherein the buying request is initiated by application of a smart card, having software embodied therein, to a secure login smart card reader connected to a public access network.

48. The fiduciary system according to claim 47 wherein the buying request is sent by a buyer system to a fiduciary system in response to a single action being performed by the buyer system.

49. A method for buying at least one item using a single-step buyer system, the method comprising:
a) identifying the at least one item;
b) disclosing a single step indicator to be submitted so as to purchase the identified item; and
c) sending the single-step indicator to a fiduciary to buy the at least one identified item on behalf of the buyer, responsive to the single step indicator,
whereby the item is bought independently of the buyer and the purchase is fulfilled while preserving and protecting the privacy of the buyer.

50. A method according to claim 49 wherein said step b) of disclosing a single step indicator includes prior to said step b), the additional step of logging on to a fiduciary website.

51. A method according to claim 49 wherein said step c) of sending the single-step indicator to a fiduciary includes identifying additional information needed to generate an order for the item by the fiduciary.

52. A method according to claim 49, wherein the fiduciary system and the buyer system communicate via a public access network.

53. A method according to claim 49 includes an additional step of sending a confirmation to the buyer system that the order has been generated by the fiduciary system.

54. A method according to claim 49 wherein said step c) of sending the single step indicator includes the sub-step of entering a single stroke purchase command when a cursor is positioned over a predefined area of displayed information.

55. A method according to claim 49 wherein the single step indicator is an indicator step selected from the group comprising:
a) generating a sound signal by the buyer;
b) using a television remote control;
c) depressing of a key on a key pad;
d) selecting a pointing device;
e) touching a touch screen; and
f) selecting a displayed indication.

56. A method according to claim 49 wherein said step b) of disclosing the single step indicator includes a step selected from the group comprising:
a) displaying predetermined information supplied by the fiduciary system as to the identity of the buyer of the buyer system;
b) displaying predetermined shipping information supplied by the buyer system;
c) displaying predetermined payment information supplied by the buyer system; and
d) displaying information for identifying a shipping address for the buyer.

57. A method of conducting a point of sale transaction by use of a buyer identifier device between a buyer, a seller, and a fiduciary, in respect of at least one item to be purchased by the buyer from the seller, whereby the privacy of the buyer is preserved, said method comprises:
a) for a buyer,
i) recording an item identifier and a seller identifier for at least one item,
ii) applying said buyer identifier device to a reader device of the seller, thereby to identify the buyer, and
iii) sending a purchase request to a fiduciary system to purchase the at least one item together with the seller identifier and the sale transaction details; and
b) for a fiduciary system
i) receiving the purchase request and the sale transaction details,
ii) retrieving buyer data from a fiduciary database relating to the buyer identifier device,
iii) confirming the identity of the buyer in accordance with the buyer identifier device and a buyer identifier code sent by the seller, and
iv) authorizing the seller to fill the purchase request received from the buyer in accordance with the sale transaction details, while retaining the confidentiality of buyer specific data contained in the fiduciary database.

58. A method of conducting a point of sale transaction according to claim 57, wherein said buyer identifier device is a portable data storage device encoded with predetermined information selected from the group comprising:
a) a buyer code;
b) a buyer password; and
c) a fiduciary identifier code.

59. A method of conducting a point of sale transaction according to claim 58, wherein said portable data storage device includes a facility to record the seller identifier and the sale transaction details.

60. A method of conducting a point of sale transaction according to claim 58, wherein said portable data storage device is password protected.

61. A method of conducting a point of sale transaction according to claim 57, wherein said buyer identifier device is a mobile electronic device.
